(19) United States
(12) Patent Application Publication
(10) Pub. No.: US 2024/0384909 A1
(43) Pub. Date: Nov. 21, 2024

(54) MULTI-SPLIT AIR CONDITIONER AND CONTROL METHOD THEREFOR, STORAGE MEDIUM, AND ELECTRONIC DEVICE

(71) Applicants: GD MIDEA HEATING & VENTILATING EQUIPMENT CO., LTD., Foshan (CN); HEFEI MIDEA HEATING & VENTILATING EQUIPMENT CO., LTD., Hefei (CN)

(72) Inventors: Yunpeng JIANG, Foshan (CN); Xiaohong WU, Foshan (CN); Huazhou YAN, Foshan (CN); Pengfei LI, Foshan (CN); Zhilin HUANG, Foshan (CN)

(21) Appl. No.: 18/688,754

(22) PCT Filed: Mar. 3, 2023
(86) PCT No.: PCT/CN2023/079615

§ 371 Date: Mar. 2, 2024

(30) Foreign Application Priority Data
Mar. 24, 2022 (CN) 202210302226.1

(51) Int. Cl. F25B 49/02

(52) U.S. Cl. CPC F25B 49/022; F25B 2500/13; F25B 2500/26; F25B 2500/31; F25B 2700/1931; F25B 2700/2104; F25B 2700/2106

(57) ABSTRACT

A control method includes obtaining a theoretical discharge pressure according to a geometric parameter of an outdoor unit of a multi-split air conditioner, an air supply port parameter of an indoor unit of the multi-split air conditioner, an outdoor ambient temperature, and an indoor ambient temperature, obtaining a pressure deviation according to a high pressure of the outdoor unit and the theoretical discharge pressure, and performing starting control of the multi-split air conditioner according to the pressure deviation.

### CROSS-REFERENCE TO RELATED APPLICATION

This application claims priority to Chinese Patent Application No. 202210302226.1 filed on Mar. 24, 2022 and entitled “MULTI-SPLIT AIR CONDITIONER AND CONTROL METHOD THEREFOR, STORAGE MEDIUM, AND ELECTRONIC DEVICE,” the entire content of which is incorporated herein by reference.

### FIELD

The present disclosure relates to the technical field of air conditioner, and more particularly, to a multi-split air conditioner, a control method thereof, a storage medium, and an electronic device.

### BACKGROUND

At present, a lower limit of an operating range of heating by a multi-split air conditioner at a low-temperature has reached −30° C. Compared with the regular heating conditions, the starting and operating conditions of ultra-low-temperature heating are more severe, especially for a long period of ultra-low-temperature standby. For a system with multiple refrigerant conditions and having a drop height with an indoor unit above an outdoor unit, when the starting of the ultra-low temperature heating after a long period of ultra-low temperature standby is performed, a large amount of low temperature liquid refrigerant migrates to the outdoor unit side of the multi-split system due to gravity and temperature difference, resulting in a large amount of liquid refrigerant in the outdoor unit heat exchanger, the low pressure tank and the compressor, while the full liquid refrigerant in the low pressure tank means that the low pressure tank directly returns the liquid refrigerant to the compressor air return port when the compressor starts, which will inevitably result in a large amount of liquid in the suction air of the compressor, leading to abnormal starting of the compressor, abnormal vibration of the system pipeline and serious damage to the compressor.

### SUMMARY

The present disclosure is intended to solve at least one of the technical problems in the related art to some extent. To this end, it is an object of the present disclosure to provide a multi-split air conditioner and a control method therefor, a storage medium, and an electronic device, which change a situation where the multi-split air conditioner is started and then protected for heating at a low-temperature, improve the reliability of the multi-split air conditioner, and reduce the maintenance cost of the multi-split air conditioner.

In a first aspect, the present disclosure provides a control method for a multi-split air conditioner including an outdoor unit and an indoor unit, the method including: obtaining a theoretical discharge pressure according to the geometric parameters of the outdoor unit, air supply port parameters of an indoor unit, an outdoor ambient temperature, and an indoor ambient temperature; obtaining a pressure deviation according to the high pressure of the outdoor unit and the theoretical discharge pressure; and performing starting control of the multi-split system according to the pressure deviation.

In a second aspect, the present disclosure provides a computer-readable storage medium, having stored thereon a computer program which, when executed by a processor, implements the method of the above-described embodiments.

In a third aspect, the present disclosure provides an electronic device including a memory, a processor and a computer program stored on the memory, wherein the computer program, when executed by the processor, implements the method of the above embodiments.

In a fourth aspect, the present disclosure provides a multi-split air conditioner including the electronic device of the above embodiment.

The multi-split air conditioner and the control method thereof, the storage medium and the electronic device of an embodiment of the present disclosure are based on system parameters of the multi-split system before the starting of the low-temperature heating, firstly, a starting severity degree is evaluated, and then the evaluation result is used as a selection basis of a system starting strategy, so as to change a situation where the multi-split air conditioner is firstly started and then is protected for the low-temperature heating, and by starting a diagnosis, a system and a compressor are further protected, thereby improving the reliability of the multi-split air conditioner and reducing maintenance costs of the multi-split air conditioner.

Additional aspects and advantages of the present disclosure will be set forth in part in the description which follows and, in part, will be obvious from the description, or may be learned by practice of the present disclosure.

### BRIEF DESCRIPTION OF DRAWINGS

FIG. 1 is a schematic flow chart of a control method for a multi-split air conditioner according to at least one embodiment of the present disclosure;

FIG. 2 is a schematic diagram illustrating a structure of a multi-split air conditioner according to at least one embodiment of the present disclosure.

### DETAILED DESCRIPTION OF EMBODIMENTS

With an increasing demand of heating ventilation air conditioning market, in order to meet the needs of customers in all aspects, a multi-split air conditioner as part of the air conditioning market also faces greater challenges. One need is that the multi-split air conditioner can operate reliably over a wider range of cooling and heating operations. Therefore, the long period standby low-temperature heating start of the multi-split air conditioner is a subject that needs to be taken seriously when designing the multi-split air conditioner. At present, many manufacturers of multi-split air conditioner have carried out a lot of control optimization on the starting process of low-temperature heating in view of the above-mentioned subject, so as to avoid the problems of liquid impact and vibration of a compressor. However, none of the above-mentioned technologies involves the identification of system parameters before starting, and in fact, if the system is in a state where the refrigerant is excessive and the refrigerant migration on the outdoor unit side is serious, it is not suitable to directly start the system, because the compressor must return liquid, resulting in internal wear and requiring additional measures to weaken the refrigerant migration effect and then try to start the system. In order to solve the above problems, the present disclosure provides a multi-split air conditioner, a control method thereof, a storage medium, and an electronic device.

Reference will now be made in detail to the embodiments of the present disclosure, examples of which are illustrated in the accompanying drawings, wherein like reference numerals refer to the same or similar elements, or elements having same or similar function throughout the several views. The embodiments described below with reference to the figures are exemplary and are intended to be illustrative of the present disclosure and are not to be construed as limiting the present disclosure.

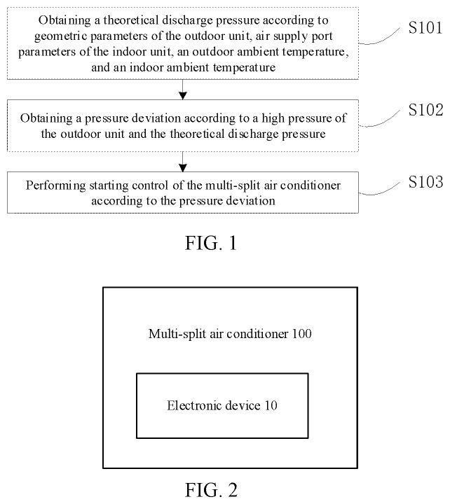

Hereinafter, a multi-split air conditioner, a control method thereof, a storage medium, and an electronic device according to an embodiment of the present disclosure will be described with reference to FIGS. 1 and 2.

FIG. 1 is a schematic flow chart of a control method for a multi-split air conditioner according to at least one embodiment of the present disclosure.

In at least one embodiment of the present disclosure, the multi-split air conditioner includes an outdoor unit and an indoor unit, wherein the outdoor unit is disposed outdoors, the indoor unit is disposed indoors, the number of the indoor units may be one or more, the outdoor unit is connected to each of the indoor units through piping, and the outdoor unit includes a compressor.

Further, the outdoor unit further includes an oil separator, a four-way valve and an air-liquid separator, wherein a discharge port of the air-liquid separator is connected to an air return port of the compressor via an air return pipe, an air outlet of the compressor is connected to an air inlet of the oil separator, a discharge port of the oil separator is connected to a first end of the four-way valve, a second end of the four-way valve is connected to one end of an indoor heat exchanger of the indoor unit via an air pipe, the other end of the indoor heat exchanger is connected to one end of an outdoor heat exchanger via a liquid pipe, the other end of the outdoor heat exchanger is connected to a third end of the four-way valve, and a fourth end of the four-way valve is connected to an inlet of the air-liquid separator. Each of the indoor units includes the indoor heat exchanger, and the outdoor unit further includes the outdoor heat exchanger and a throttling device connected between the outdoor heat exchanger and the indoor heat exchanger. The throttling device may be an electronic expansion valve.

As shown in FIG. 1, a control method for a multi-split air conditioner includes:

S101: obtaining a theoretical discharge pressure according to geometric parameters of the outdoor unit, air supply port parameters of the indoor unit, an outdoor ambient temperature, and an indoor ambient temperature.

In some embodiments, in a single refrigerant circulation system, the geometric parameters (which may include: length OduLᵢ, width OduWᵢ, and height OduHᵢ) of all outdoor units, the air supply port parameters (which may include: length IduLᵢ, width IduWᵢ of an air supply port) of all indoor units, the outdoor ambient temperature sensor values T4ᵢ of each outdoor unit, and the indoor ambient sensor temperature T1ᵢ of each indoor unit are obtained first. The number of outdoor units of the multi-split air conditioner is M, and the number of indoor units is N. In addition, the geometric parameters of the outdoor unit and the air supply port parameters of the indoor unit are inherent parameters of the refrigerant circulation system and can be stored in advance for direct acquisition; the outdoor ambient temperature may be measured in real time by a temperature sensor provided on the outdoor unit, and the indoor ambient temperature may be measured in real time by a temperature sensor provided on the indoor unit. Then, the theoretical discharge pressure is obtained according to the geometric parameters of the outdoor unit, the air supply port parameters of the indoor unit, the outdoor ambient temperature, and the indoor ambient temperature.

S102: Obtaining a pressure deviation according to a high pressure of the outdoor unit and the theoretical discharge pressure.

In some embodiments, the high pressure of the outdoor unit can be obtained by a high pressure sensor provided at the air outlet of the compressor of the multi-split air conditioner, and recorded as a high pressure sensor value PCₛₑₙₛₒᵣ. Further, comparing the obtained theoretical discharge pressure value PC_{cal} with the high pressure sensor value PCₛₑₙₛₒᵣ, the pressure deviation DP can be calculated. The calculation process includes: calculating a difference between the theoretical discharge pressure and the high pressure; calculating a ratio of the difference to the high pressure to obtain the pressure deviation DP, i.e. the calculation formula of the pressure deviation DP is:

$$DP = \frac{{PC}_{cal} - {PC}_{sensor}}{{PC}_{sensor}} .$$

S103: Performing starting control of the multi-split system according to the pressure deviation.

In some embodiments, in a case where the outdoor ambient temperature is low and the normal starting of the multi-split air conditioner may cause damage, the severity degree of the starting condition of the multi-split air conditioner can be determined according to the pressure deviation, for example, when the pressure deviation is small, the starting condition can be considered to be generally severe, and at this moment, only the compressor of the outdoor unit can be preheated, and when the preheating satisfies a certain condition (such as a preheating time reaching a certain time), the normal starting logic of the multi-split air conditioner (i.e., a conventional logic suitable for direct starting) is executed; when the pressure deviation is large, it can be considered that the starting condition is relatively poor; at this moment, it is possible to perform electric auxiliary heat on the indoor unit while preheating the compressor of the outdoor unit, and the compressor starts at a specific frequency, the electronic expansion valves, etc., of the indoor unit and the outdoor unit are adjusted, and when certain conditions are met, the normal starting logic of the multi-split air conditioner is executed. Thus, a starting logic is determined according to the severity degree of the starting condition of the multi-split air conditioner, and a situation where the multi-split air conditioner is started firstly and then is protected for the low-temperature heating can be changed to improve the reliability of the multi-split air conditioner and reduce the maintenance cost of the multi-split air conditioner.

In some embodiments of the present disclosure, M, N may each be an integer greater than 1.

In this embodiment, step S101 may include: obtaining an outdoor unit radiation heat exchange area according to M geometric parameters, obtaining an indoor unit radiation heat exchange area according to N air supply port parameters, obtaining an outdoor unit average ambient temperature according to M outdoor ambient temperatures, and obtaining an indoor unit average ambient temperature according to N indoor ambient temperatures; obtaining a theoretical discharge saturation temperature and a theoretical suction saturation temperature according to the outdoor unit radiation heat exchange area, the indoor unit radiation heat exchange area, the outdoor unit average ambient temperature and the indoor unit average ambient temperature; and obtaining the theoretical discharge pressure according to the theoretical discharge saturation temperature and the theoretical suction saturation temperature.

In some other embodiments of the present disclosure, both M and N have a value of 1.

In this embodiment, the calculation of the outdoor unit average ambient temperature and the indoor unit average ambient temperature may not be performed, and the theoretical discharge saturation temperature and the theoretical suction saturation temperature may be obtained directly according to the outdoor unit radiation heat exchange area, the indoor unit radiation heat exchange area, the outdoor ambient temperature and the indoor ambient temperature.

In some embodiments, the outdoor unit radiation heat exchange area can be obtained by the following formula:

$${A}_{odu} = {\sum }_{i = 1}^{M} [ 2 \times ( {OduL}_{i} + {OduW}_{i} ) \times 0 + {OduL}_{i} \times {OduW}_{i} ] ,$$

wherein A_{odu} represents the outdoor unit radiation heat exchange area, OduLᵢ, OduWᵢ, and OduHᵢ represent respectively the length, width and height of the i^{th} outdoor unit.

The indoor unit radiation heat exchange area can be obtained by the following formula:

$${A}_{idu} = {\sum }_{i = 1}^{N} ( {IduL}_{i} \times {IduW}_{i} ) ,$$

wherein A_{idu} represents the indoor unit radiation heat exchange area, and IduLᵢ and IduWᵢ represent respectively the length and width of the air supply port of the i^{th} indoor unit.

The outdoor unit average ambient temperature can be obtained by the following formula:

$$T {4}_{avg} = \frac{1}{M} {\sum }_{i = 1}^{M} T {4}_{i} ,$$

wherein T4_{avg} represents the outdoor unit average ambient temperature, and T4ᵢ represents the outdoor ambient temperature collected by the temperature sensor provided on the i^{th} outdoor unit.

The indoor unit average ambient temperature can be obtained by:

$$T {1}_{avg} = \frac{1}{N} {\sum }_{i = 1}^{N} T {1}_{i} ,$$

wherein T1_{avg} represents the indoor unit average ambient temperature, and T1ᵢ represents the indoor ambient temperature collected by the temperature sensor provided on the i^{th} indoor unit.

Further, according to the above-mentioned outdoor unit radiation heat exchange area A_{odu}, indoor unit radiation heat exchange area A_{idu}, outdoor unit average ambient temperature T4_{avg} and indoor unit average ambient temperature T1_{avg}, the theoretical discharge saturation temperature Tc and the theoretical suction saturation temperature Te of the system in a relatively ideal state of the exhaust pipe, i.e., in the case that the exhaust pipe is not filled with the liquid refrigerant, can be obtained through calculation, and then the corresponding theoretical discharge pressure Pc can be obtained through physical property parameter query. If the corresponding relationship between the theoretical discharge saturation temperature Tc and the theoretical suction saturation temperature Te and the theoretical discharge pressure Pc can be stored in advance, after obtaining the theoretical discharge saturation temperature Tc and the theoretical suction saturation temperature Te, the corresponding relationship can be directly searched to obtain the corresponding theoretical discharge pressure Pc.

In this embodiment, the theoretical discharge saturation temperature Tc, the theoretical suction saturation temperature Te can be obtained by the following formula:

$${Q}_{power} = ε {}_{1} {A}_{odu} ( Tc - T {4}_{avg} ) = ε {}_{2} {A}_{idu} ( T {1}_{avg} - Te ) , and Tc = Te ,$$

wherein Q_{power} represents a theoretical heat exchange intensity, A_{odu} represents the outdoor unit radiation heat exchange area, A_{idu} represents the indoor unit radiation heat exchange area, ε₁, represents a first coefficient, ε₂ represents a second coefficient, Tc represents the theoretical discharge saturation temperature, Te represents the theoretical suction saturation temperature, T4_{avg} represents the outdoor unit average ambient temperature, and T1_{avg} represents the indoor unit average ambient temperature.

In at least one embodiment of the present disclosure, step S103 includes: controlling the multi-split air conditioner to execute a normal starting flow in response to a determination that the pressure deviation is greater than or equal to a first deviation; in response to a determination that the pressure deviation is smaller than the first deviation and greater than or equal to a second deviation, preheating the multi-split air conditioner for a second preset time length, then controlling the compressor to operate at a minimum allowable operating frequency for a third preset time length, and then controlling the multi-split air conditioner to execute the normal starting flow; and in response to a determination that the pressure deviation is smaller than the second deviation, preheating the multi-split air conditioner until a difference between an air outlet temperature of the compressor and a condensation temperature of the multi-split air conditioner is greater than a second difference threshold, and controlling the multi-split air conditioner to execute the normal starting flow; wherein a heating power for preheating is greater than or equal to the theoretical heat exchange intensity, the theoretical heat exchange intensity is obtained according to the outdoor unit radiation heat exchange area, the indoor unit radiation heat exchange area, the outdoor unit average ambient temperature and the indoor unit average ambient temperature.

In some embodiments, if the pressure deviation DP≥DPₛₑₜ₁ (i.e. the first deviation) is detected, it can be considered that the starting condition of the multi-split air conditioner is appropriate, at this time, the multi-split air conditioner can be directly controlled to execute the normal starting flow. If the pressure deviation DP<DPₛₑₜ₁ (i.e., the first deviation) and the pressure deviation DP≥DPₛₑₜ₂ (i.e., the second deviation) are detected, it can be considered that the starting condition of the multi-split air conditioner is poor, at this time, a starting strategy I can be adopted to execute the starting flow, wherein the starting strategy I can be specifically: after the multi-split air conditioner is powered on, a pre-starting action is executed, i.e., a preheating measure (including one or more of a compressor crankshaft heating, a compressor electric heating belt, a low-pressure tank electric heating belt and a chassis heating) is started, and after maintaining the Tₚᵣₑₕₑₐₜ₁ time length (i.e., the second preset time length), the compressor is controlled to operate at the minimum allowable operating frequency for the T_{minhz1} time length (i.e., the third preset time length), and then the multi-split air conditioner is controlled to execute the normal starting flow.

If the pressure deviation DP<DPₛₑₜ₂ (i.e. the second deviation) is detected, it can be considered that the starting condition of the multi-split air conditioner is bad, at this time, a starting strategy II can be adopted to execute the starting flow. The starting strategy II can be specifically: after the multi-split air conditioner is powered on, a pre-starting action is executed, i.e., a preheating measure (including one or more of compressor crankshaft heating, a compressor electric heating belt, a low-pressure tank electric heating belt and a chassis heating) is started, during this period, the air outlet temperature TP of the compressor and the condensation temperature TC of the multi-split air conditioner can be collected in real time, and when a difference value between the air outlet temperature of the compressor and the condensation temperature of the multi-split air conditioner, i.e., a value of TP−TC, is greater than the second difference value threshold (such as a minimum starting discharge superheat degree TDSHₘᵢₙ), the preheating is determined to be finished, and then the multi-split air conditioner is controlled to execute the normal starting flow.

The heating power for preheating is greater than or equal to the theoretical heat exchange intensity Q_{power} calculated above.

As an example, the first deviation DPₛₑₜ₁ and the second deviation DPₛₑₜ₂ are not fixed values, but are obtained according to the heat exchanger area and the internal volume of the outdoor unit and the indoor unit of the current system, i.e. the values of the first preset deviation DPₛₑₜ₁ and the second preset deviation DPₛₑₜ₂ in different system configurations are different.

As an example, during the executing of the normal starting flow after preheating, the method may further include: calculating a current fluctuation amplitude according to a starting current; and in response to a determination that the current fluctuation amplitude is greater than a preset amplitude threshold, stopping the normal starting flow, and returning to the step of preheating.

In some embodiments, after the preliminary starting action is completed, additional monitoring of the starting current is required during the implementation of the normal chiller starting strategy, and the starting current can be monitored by monitoring an instantaneous current fluctuation value when the compressor is driven. After the pre-starting time is eliminated, the current values Aᵢ and Aᵢ₊₁ at any two adjacent acquisition moments are recorded in real time, and the current values Aᵢ and Aᵢ₊₁ are used to calculate the current fluctuation amplitude d_{A}. The calculation method is similar to that of the above-mentioned pressure deviation, and the calculation formula is as follows:

$${d}_{A} = \frac{( {A}_{i + 1} - {A}_{i} )}{{A}_{i}} .$$

If it is identified that d_{A} exceeds the current fluctuation limit maximum value DAₘₐₓ (i.e., the preset amplitude threshold value), it can be considered that there is an abnormal starting of the compressor, at this time, it is necessary to stop this normal starting flow at once and return to the step of preheating.

It should be understood that the entire starting control flow ends when the normal starting flow is normally executed.

It should be noted that in general, after the multi-split air conditioner has been in a long time low-temperature standby, there is a problem that a large amount of liquid is taken in the suction air of the compressor, leading to an abnormal start of the compressor, causing abnormal vibration of the system pipeline and serious damage to the compressor. Therefore, it is possible to determine the starting condition of the multi-split air conditioner before executing the step S101.

As an embodiment of the present disclosure, before the theoretical discharge pressure is obtained, it is necessary to acquire low-temperature starting condition parameters of the multi-split air conditioner, determine whether the low-temperature starting condition parameters satisfy a preset low-temperature starting condition, and if the low-temperature starting condition parameters satisfy the preset low-temperature starting condition, performing the step of obtaining the theoretical discharge pressure according to the geometric parameters, the air supply port parameters, the outdoor ambient temperature and the indoor ambient temperature.

The low-temperature starting condition parameters include a standby time length of the multi-split air conditioner, the air outlet temperature of the compressor and the outdoor ambient temperature, and the preset low-temperature starting condition is any one of the following: the standby time length is greater than or equal to a first preset time length, and the outdoor ambient temperature is smaller than or equal to a first preset temperature; or the difference between the air outlet temperature of the compressor and the outdoor ambient temperature is smaller than or equal to a first difference threshold, and the outdoor ambient temperature is smaller than or equal to the first preset temperature.

In some embodiments, when the standby time length T0 is greater than or equal to a minimum standby time length TimeOff_Max (i.e., the first preset time length), i.e., T0≥TimeOff_Max, and the outdoor ambient temperature T4 is smaller than or equal to a maximum temperature T4ₘₐₓ (i.e., the first preset temperature) in the low-temperature starting mode, i.e., T4≤T4ₘₐₓ; or, when the difference between the air outlet temperature TP of the compressor and the outdoor ambient temperature T4 is smaller than or equal to the first difference threshold dT4ₘₐₓ, i.e., |TP−T4|≤dT4ₘₐₓ, and the outdoor ambient temperature T4 is smaller than or equal to the first preset temperature T4ₘₐₓ, performing the step of obtaining the theoretical discharge pressure according to the geometric parameters, the air supply port parameters, the outdoor ambient temperature and the indoor ambient temperature.

The outdoor ambient temperature T4 may be an outdoor ambient temperature corresponding to any outdoor unit, or may also be an average value of a plurality of outdoor ambient temperatures. The first difference threshold may be a minimum value, such as a value between 0.01 and 0.5. In this case, the air outlet temperature of the compressor is substantially equal to the outdoor ambient temperature.

In summary, the control method of the multi-split system is based on the system parameters of the multi-split air conditioner before the starting of the low-temperature heating, the pressure deviation is firstly obtained through the system parameters, and a starting severity degree is evaluated according to the pressure deviation, and then the evaluation result is used as a selection basis of a system starting strategy, so as to change a situation where the multi-split air conditioner is firstly started and then is protected for the low-temperature heating, and by starting a diagnosis, a system and a compressor are further protected, thereby improving the reliability of the multi-split air conditioner and reducing maintenance costs of the multi-split air conditioner.

The present disclosure provides a computer-readable storage medium based on the control method for the multi-split air conditioner according to the above embodiment.

In an embodiment of the present disclosure, a computer program is stored on the computer-readable storage medium, and the computer program, when executed by a processor, implements the control method for the multi-split air conditioner of the above-described embodiment.

The computer-readable storage medium according to an embodiment of the present disclosure, when a computer program corresponding to the above-mentioned control method stored thereon is executed, can change a situation where the multi-split air conditioner is firstly started and then is protected for the low-temperature heating and further protect a system and a compressor by diagnosing a severity degree of a starting condition and performing a starting control according to a diagnosis result, thereby improving reliability of the multi-split air conditioner and reducing maintenance costs of the multi-split air conditioner.

The present disclosure also provides an electronic device based on the control method for the multi-split air conditioner according to the above embodiment.

In an embodiment of the present disclosure, the electronic device includes a memory, a processor, and a computer program stored on the memory, wherein the computer program, when executed by the processor, implements the control method for the multi-split air conditioner of the above-described embodiment.

The electronic device according to an embodiment of the present disclosure executes a computer program corresponding to the above-mentioned control method stored on a memory by a processor, and changes a situation where the multi-split air conditioner is firstly started and then is protected for the low-temperature heating and further protect a system and a compressor by diagnosing a severity degree of a starting condition and performing a starting control according to a diagnosis result, thereby improving reliability of the multi-split air conditioner and reducing maintenance costs of the multi-split air conditioner.

Further, the present disclosure provides a multi-split air conditioner.

FIG. 2 is a block diagram showing a multi-split air conditioner according to at least one embodiment of the present disclosure.

As shown in FIG. 2, the multi-split air conditioner 100 includes the electronic device 10 of the above-described embodiment.

In at least one embodiment of the present disclosure, the multi-split air conditioner includes an outdoor unit and an indoor unit, wherein the outdoor unit is disposed outdoors, the indoor unit is disposed indoors, the number of the indoor units may be one or more, the outdoor unit is connected to each of the indoor units through piping, and the outdoor unit includes a compressor.

Further, the outdoor unit further includes an oil separator, a four-way valve and an air-liquid separator, wherein a discharge port of the air-liquid separator is connected to an air return port of the compressor via an air return pipe, an air outlet of the compressor is connected to an air inlet of the oil separator, a discharge port of the oil separator is connected to a first end of the four-way valve, a second end of the four-way valve is connected to one end of an indoor heat exchanger of the indoor unit via an air pipe, the other end of the indoor heat exchanger is connected to one end of an outdoor heat exchanger via a liquid pipe, the other end of the outdoor heat exchanger is connected to a third end of the four-way valve, and a fourth end of the four-way valve is connected to an inlet of the air-liquid separator. Each of the indoor units includes the indoor heat exchanger, and the outdoor unit further includes the outdoor heat exchanger and a throttling device connected between the outdoor heat exchanger and the indoor heat exchanger. The throttling device may be an electronic expansion valve.

The multi-split air conditioner according to an embodiment of the present disclosure can further protect the system and the compressor by the above-described electronic device, thereby improving the reliability of the multi-split air conditioner and reducing the maintenance cost of the multi-split air conditioner.

It should be noted that the logic and/or steps represented in the flowcharts or otherwise described herein, such as an ordered listing of executable instructions that can be considered to implement logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. For the purposes of this specification, a “computer-readable medium” can be any means that can contain, store, communicate, propagate, or transport the program for use by or in connection with the instruction execution system, apparatus, or device. More specific examples (a non-exhaustive list) of computer-readable media include the following: an electrical connection (electronic device) having one or more wirings, a portable computer disc cartridge (magnetic device), a random access memory (RAM), a read-only memory (ROM), an erasable programmable read-only memory (EPROM or flash memory), an optical fiber device, and a portable optical disc read-only memory (CDROM). In addition, the computer-readable medium may even be paper or other suitable medium upon which the program is printed, as the program may be electronically obtained, such as by optically scanning the paper or other medium, followed by editing, interpreting, or otherwise processing in a suitable manner if necessary, and then stored in a computer memory.

It should be understood that portions of the present disclosure may be implemented in hardware, software, firmware, or a combination thereof. In the embodiments described above, the steps or methods may be implemented in software or firmware stored in memory and executed by a suitable instruction execution system. For example, if implemented in hardware, as in another embodiment, it may be implemented using any one or a combination of the following techniques known in the art: discrete logic circuits with logic gates for implementing logic functions on data signals, application specific integrated circuits with appropriate combinational logic gates, programmable gate arrays (PAir), field programmable gate arrays (FPAir), etc.

In describing the description, reference to the description of the terms “an embodiment,” “some embodiments,” “an example,” “particular examples,” or “some examples,” etc., means that a particular feature, structure, material, or characteristic described in connection with the embodiment or example is included in at least an embodiment or example of the present disclosure. In this description, schematic representations of the above terms do not necessarily refer to the same embodiment or example. Further, the particular features, structures, materials, or characteristics described may be combined in any suitable manner in any one or more embodiments or examples.

In the description of the present disclosure, it is to be understood that the terms “center,” “longitudinal,” “lateral,” “length,” “width,” “thickness,” “upper,” “lower,” “front,” “rear,” “left,” “right,” “vertical,” “horizontal,” “top” “bottom,” “inner,” “outer,” “clockwise,” “counterclockwise,” “axial,” “radial,” “circumferential,” and the like, indicate orientations or positional relationships based on those shown in the drawings, merely for convenience of description and simplification of the description, and do not indicate or imply that the device or element referred to must have a particular orientation, be constructed in a particular orientation, and be operated, and thus, are not to be construed as limiting the present disclosure.

Further, the terms “first” and “second” are used for descriptive purposes only and are not to be construed as indicating or implying relative importance or implicitly indicating the number of technical features indicated. Thus, features defining “first” and “second” may explicitly or implicitly include at least one such feature. In the description of the present disclosure, “a plurality of” refers to at least two, e.g. two, three, etc. unless specifically and specifically limited otherwise.

In the present disclosure, unless explicitly stipulated and limited otherwise, the terms “mounted,” “coupled,” “connected,” “fixed” and the like are to be understood in a broad sense, for example, they may be fixedly connected or detachably connected, or integrated; may be a mechanical connection or an electrical connection; it can be directly connected or indirectly connected through an intermediate medium, and can be the communication between two elements or the interaction relationship between two elements unless explicitly defined otherwise. The specific meaning of the above terms in the present disclosure can be understood by a person skilled in the art according to specific circumstances.

In the present disclosure unless expressly specified and limited otherwise, the first feature “on” or “under” the second feature may be that the first and second features are in direct contact, or that the first and second features are in indirect contact through an intermediary. Further, the first feature being “on,” “above” and “over” the second feature may be directly above or obliquely above the second feature or merely indicate that the first feature is at a higher level than the second feature. The first feature being “under,” “below” and “beneath” the second feature may be that the first feature is directly below or obliquely below the second feature, or simply that the first feature has a smaller level than the second feature.

While embodiments of the present disclosure have been shown and described, it will be understood that the above-described embodiments are illustrative and not restrictive, and that changes, modifications, substitutions and alterations may be made by a person skilled in the art without departing from the scope of the present disclosure.

1.-10. (canceled)

11. A control method comprising:
obtaining a theoretical discharge pressure according to a geometric parameter of an outdoor unit of a multi-split air conditioner, an air supply port parameter of an indoor unit of the multi-split air conditioner, an outdoor ambient temperature, and an indoor ambient temperature;
obtaining a pressure deviation according to a high pressure of the outdoor unit and the theoretical discharge pressure; and
performing starting control of the multi-split air conditioner according to the pressure deviation.

12. The method according to claim 11, wherein:
obtaining the theoretical discharge pressure includes obtaining the theoretical discharge pressure in response to a determination that a standby time of the multi-split air conditioner is greater than or equal to a preset time length, and the outdoor ambient temperature is smaller than or equal to a preset temperature.

13. The method according to claim 11, wherein:
the outdoor unit is one of M outdoor units of the multi-split air conditioner, the indoor unit is one of N indoor units of the multi-split air conditioner, and each of M and N is an integer equal to or greater than 1; and
obtaining the theoretical discharge pressure includes:
obtaining an outdoor unit radiation heat exchange area according to M geometric parameters, obtaining an indoor unit radiation heat exchange area according to N air supply port parameters, obtaining an outdoor unit average ambient temperature according to M outdoor ambient temperatures, and obtaining an indoor unit average ambient temperature according to N indoor ambient temperatures;
obtaining a theoretical discharge saturation temperature and a theoretical suction saturation temperature according to the outdoor unit radiation heat exchange area, the indoor unit radiation heat exchange area, the outdoor unit average ambient temperature, and the indoor unit average ambient temperature; and
obtaining the theoretical discharge pressure according to the theoretical discharge saturation temperature and the theoretical suction saturation temperature.

14. The method according to claim 11, wherein performing starting control of the multi-split system according to the pressure deviation includes:
controlling the multi-split air conditioner to execute a normal starting flow in response to a determination that the pressure deviation is greater than or equal to a first deviation;
in response to a determination that the pressure deviation is smaller than the first deviation and greater than or equal to a second deviation, preheating the multi-split air conditioner for a first preset time length, then controlling a compressor to operate at a minimum allowable operating frequency for a second preset time length, and then controlling the multi-split air conditioner to execute the normal starting flow; and
in response to a determination that the pressure deviation is smaller than the second deviation, preheating the multi-split air conditioner until a difference between an air outlet temperature of the compressor and a condensation temperature of the multi-split air conditioner is greater than a difference threshold, and then controlling the multi-split air conditioner to execute the normal starting flow.

15. The method according to claim 14, further comprising, during executing the normal starting flow after preheating:
calculating a current fluctuation amplitude according to a starting current; and
in response to a determination that the current fluctuation amplitude is greater than a preset amplitude threshold, stopping the normal starting flow, and returning to preheating.

16. The method according to claim 14, wherein a heating power for preheating is greater than or equal to a theoretical heat exchange intensity.

17. The method according to claim 16, wherein the theoretical heat exchange intensity is obtained according to an outdoor unit radiation heat exchange area, an indoor unit radiation heat exchange area, the outdoor ambient temperature, and the indoor ambient temperature.

18. The method according to claim 16, wherein:
the outdoor unit is one of M outdoor units of the multi-split air conditioner, the indoor unit is one of N indoor units of the multi-split air conditioner, and each of M and N is an integer equal to or greater than 1; and
the theoretical heat exchange intensity is obtained according to:
an outdoor unit radiation heat exchange area obtained according to M geometric parameters,
an indoor unit radiation heat exchange area obtained according to N air supply port parameters,
an outdoor unit average ambient temperature obtained according to M outdoor ambient temperatures, and
an indoor unit average ambient temperature obtained according to N indoor ambient temperatures.

19. The method according to claim 18, wherein the theoretical discharge saturation temperature Tc, the theoretical suction saturation temperature Te, and the theoretical heat exchange intensity Q_{power} are obtained by:
$${Q}_{power} = {ε}_{1} {A}_{odu} ( Tc - T {4}_{avg} ) = {ε}_{2} {A}_{idu} ( T {1}_{avg} - Te ) , and Tc = Te ,$$
wherein A_{odu} represents the outdoor unit radiation heat exchange area, A_{idu} represents the indoor unit radiation heat exchange area, ε₁ represents a first coefficient, ε₂ represents a second coefficient, T4_{avg} represents the outdoor unit average ambient temperature, and T1_{avg} represents the indoor unit average ambient temperature.

20. The method according to claim 11, wherein obtaining the pressure deviation according to the high pressure and the theoretical discharge pressure includes:
calculating a difference between the theoretical discharge pressure and the high pressure; and
calculating a ratio of the difference to the high pressure to obtain the pressure deviation.

21. A non-transitory computer-readable storage medium storing one or more computer programs that, when executed by one or more processors, cause the one or more processors to:
obtain a theoretical discharge pressure according to a geometric parameter of an outdoor unit of a multi-split air conditioner, an air supply port parameter of an indoor unit of the multi-split air conditioner, an outdoor ambient temperature, and an indoor ambient temperature;
obtain a pressure deviation according to a high pressure of the outdoor unit and the theoretical discharge pressure; and
perform starting control of the multi-split air conditioner according to the pressure deviation.

22. An electronic device comprising:
one or more processors; and
one or more memories storing one or more computer programs that, when executed by the one or more processors, cause the one or more processors to:
obtain a theoretical discharge pressure according to a geometric parameter of an outdoor unit of a multi-split air conditioner, an air supply port parameter of an indoor unit of the multi-split air conditioner, an outdoor ambient temperature, and an indoor ambient temperature;
obtain a pressure deviation according to a high pressure of the outdoor unit and the theoretical discharge pressure; and
perform starting control of the multi-split air conditioner according to the pressure deviation.

23. The electronic device according to claim 22, wherein the one or more computer programs, when executed by the one or more processors, further cause the one or more processors to:
obtain the theoretical discharge pressure in response to a determination that a standby time of the multi-split air conditioner is greater than or equal to a preset time length, and the outdoor ambient temperature is smaller than or equal to a preset temperature.

24. The electronic device according to claim 22, wherein:
the outdoor unit is one of M outdoor units of the multi-split air conditioner, the indoor unit is one of N indoor units of the multi-split air conditioner, and each of M and N is an integer equal to or greater than 1; and
the one or more computer programs, when executed by the one or more processors, further cause the one or more processors to:
obtain an outdoor unit radiation heat exchange area according to M geometric parameters, obtain an indoor unit radiation heat exchange area according to N air supply port parameters, obtain an outdoor unit average ambient temperature according to M outdoor ambient temperatures, and obtain an indoor unit average ambient temperature according to N indoor ambient temperatures;
obtain a theoretical discharge saturation temperature and a theoretical suction saturation temperature according to the outdoor unit radiation heat exchange area, the indoor unit radiation heat exchange area, the outdoor unit average ambient temperature, and the indoor unit average ambient temperature; and
obtain the theoretical discharge pressure according to the theoretical discharge saturation temperature and the theoretical suction saturation temperature.

25. The electronic device according to claim 22, wherein the one or more computer programs, when executed by the one or more processors, further cause the one or more processors to:
control the multi-split air conditioner to execute a normal starting flow in response to a determination that the pressure deviation is greater than or equal to a first deviation;
in response to a determination that the pressure deviation is smaller than the first deviation and greater than or equal to a second deviation, preheat the multi-split air conditioner for a first preset time length, then control a compressor to operate at a minimum allowable operating frequency for a second preset time length, and then control the multi-split air conditioner to execute the normal starting flow; and
in response to a determination that the pressure deviation is smaller than the second deviation, preheat the multi-split air conditioner until a difference between an air outlet temperature of the compressor and a condensation temperature of the multi-split air conditioner is greater than a difference threshold, and then control the multi-split air conditioner to execute the normal starting flow.

26. The electronic device according to claim 25, wherein the one or more computer programs, when executed by the one or more processors, further cause the one or more processors to, during executing the normal starting flow after preheating:
calculate a current fluctuation amplitude according to a starting current; and
in response to a determination that the current fluctuation amplitude is greater than a preset amplitude threshold, stop the normal starting flow, and return to preheating.

27. The electronic device according to claim 25, wherein a heating power for preheating is greater than or equal to a theoretical heat exchange intensity.

28. The electronic device according to claim 27, wherein the theoretical heat exchange intensity is obtained according to an outdoor unit radiation heat exchange area, an indoor unit radiation heat exchange area, the outdoor ambient temperature, and the indoor ambient temperature.

29. The electronic device according to claim 27, wherein:
the outdoor unit is one of M outdoor units of the multi-split air conditioner, the indoor unit is one of N indoor units of the multi-split air conditioner, and each of M and N is an integer equal to or greater than 1; and
the theoretical heat exchange intensity is obtained according to:
an outdoor unit radiation heat exchange area obtained according to M geometric parameters,
an indoor unit radiation heat exchange area obtained according to N air supply port parameters,
an outdoor unit average ambient temperature obtained according to M outdoor ambient temperatures, and
an indoor unit average ambient temperature obtained according to N indoor ambient temperatures.

30. A multi-split air conditioner comprising the electronic device according to claim 22.
